(19) United States
(12) Patent Application Publication
(10) Pub. No.: US 2016/0182144 A1
(43) Pub. Date: Jun. 23, 2016

(54) Fuel Dispenser Wireless Communication Arrangement

(71) Applicant: Gilbarco Inc., Greensboro, NC (US)

(72) Inventor: Roger William Stout, Greensboro, NC (US)

(21) Appl. No.: 14/757,632

(22) Filed: Dec. 23, 2015

Related U.S. Application Data
(60) Provisional application No. 62/095,819, filed on Dec. 23, 2014.

(51) Int. Cl. H04B 7/26

(52) U.S. Cl. CPC H04B 7/26

(57) ABSTRACT

A fuel dispenser comprising a housing defining an electronics area therein. The housing has a first side and a second side, and the first and second sides respectively face first and second fueling positions. A first side axis is perpendicular to the first side, and a second side axis is perpendicular to the second side. A first wireless communication module is disposed in the electronics area. The first wireless communication module comprises wireless communication circuitry in electrical communication with at least one antenna. A first waveguide is also disposed in the electronics area and is operative to guide electromagnetic waves transmitted from the first wireless communication module toward the first fueling position. The first waveguide has a first longitudinal axis. The first waveguide is positioned such that the first longitudinal axis is at an angle with respect to the first side axis.

### PRIORITY CLAIM

This application claims the benefit of U.S. Provisional Application Ser. No. 62/095,819, titled “Fuel Dispenser Wireless Communication Arrangement,” filed Dec. 23, 2014, which is hereby relied upon and incorporated herein by reference for all purposes.

### FIELD OF THE INVENTION

The present invention relates generally to fuel dispenser and other retail payment systems. More particularly, the invention relates to systems and methods for facilitating wireless communication between a first wireless communication module associated with a first fueling position of a fuel dispenser and a mobile device of a customer at the first fueling position. Embodiments of the present invention may reduce or eliminate the possibility that the mobile device may communicate with a second wireless communication module associated with a second fueling position of the fuel dispenser or with another wireless communication module in the fuel dispensing environment.

### BACKGROUND

Fuel dispensers are designed in a variety of different configurations. A common type of fuel dispenser, often called a “lane-oriented” dispenser, has one or more fuel dispensing nozzles on each side of the unit. Each of the nozzles on each side of the unit is typically used to dispense a particular grade (e.g., octane level) of fuel. Alternatively, a single nozzle may be provided for dispensing multiple grades of fuel depending on the customer's selection. Each side of the unit generally comprises a user interface including a display for displaying the amount and cost of the fuel dispensed. The user interface can also include credit or debit card verification and cash acceptance mechanisms. An example of such a fuel dispenser interface is the card reader in dispenser (CRIND®) equipped fuel dispenser offered by Gilbarco Inc.

There have been efforts to effect payment for various goods and services via mobile devices such as cell phones. Various technologies have been implemented for this purpose. For example, U.S. Pub. App. No. 2004/0050648 discloses keying a unique vending machine (“VM”) identification number into a mobile phone that is connected to the Internet. A central server, connected to both the phone and the VM, acts as clearinghouse and establishes a “virtual connection” between the phone and the VM. An alternative way to transfer the VM identification number to a phone is via a bar code (such as a QR code) that could be dynamically generated and rendered on the VM's display. The bar code would be imaged via a camera integrated into the customer's phone.

Other techniques for effecting payment via mobile devices utilize various wireless radio frequency protocols, including near-field communication (NFC), Bluetooth, WiFi, and radio frequency identification (RFID). Additional background regarding such systems is provided in U.S. application Ser. No. 14/510,874; U.S. Pub. App. No. 2011/0295415; U.S. Pub. App. No. 2014/0019367; and U.S. Pat. No. 6,073,840. The entire disclosures of each of the foregoing applications are incorporated by reference herein for all purposes.

### SUMMARY

The present invention recognizes and addresses disadvantages of prior art constructions and methods. According to one embodiment, the present invention provides a fuel dispenser comprising a housing defining an electronics area therein. The housing has a first side and a second side, and the first and second sides respectively face first and second fueling positions. A first side axis is perpendicular to the first side, and a second side axis is perpendicular to the second side. A first wireless communication module is disposed in the electronics area. The first wireless communication module comprises wireless communication circuitry in electrical communication with at least one antenna. A first waveguide is also disposed in the electronics area and is operative to guide electromagnetic waves transmitted from the first wireless communication module toward the first fueling position. The first waveguide has a first longitudinal axis. The first waveguide is positioned such that the first longitudinal axis is at an angle with respect to the first side axis.

According to a further embodiment, the present invention provides a wireless communication assembly for use in a fuel dispensing environment. The wireless communication assembly comprises a housing having a first end and a second end, the second end having an opening therethrough. The first end is parallel with a first plane and second end opening is parallel with a second plane. A wireless communication module is disposed in the housing. The wireless communication module comprises wireless communication circuitry in electrical communication with at least one antenna. The housing is operative to guide electromagnetic waves transmitted by the wireless communication module toward the second end. The first and second planes are not parallel.

Those skilled in the art will appreciate the scope of the present invention and realize additional aspects thereof after reading the following detailed description of preferred embodiments in association with the accompanying drawing figures.

### BRIEF DESCRIPTION OF THE DRAWINGS

A full and enabling disclosure of the present invention, including the best mode thereof directed to one of ordinary skill in the art, is set forth in the specification, which makes reference to the appended drawings, in which:

FIG. 1 is a diagrammatic representation of a retail fuel dispensing environment in which an embodiment of the present invention may be utilized.

FIG. 2 is a front elevation view of an exemplary fuel dispenser that may operate within the retail fueling environment of FIG. 1.

FIG. 3 is a block diagram of a wireless communication module which may be utilized with an embodiment of the present invention.

FIG. 4 is a schematic top plan view of a fuel dispenser comprising wireless communication modules associated with each fueling position.

FIG. 5 is a front perspective view of a waveguide constructed in accordance with an embodiment of the present invention.

FIG. 6 is a back perspective view of the waveguide of FIG. 5.

FIG. 7 is a left side elevation of a wireless communication assembly in accordance with an embodiment of the present invention.

FIG. 8 is a top plan view of the wireless communication assembly of FIG. 7.

FIG. 9 is a schematic top plan view of a fuel dispenser comprising two wireless communication modules in accordance with an embodiment of the present invention.

Repeat use of reference characters in the present specification and drawings is intended to represent same or analogous features or elements of the invention.

### DETAILED DESCRIPTION OF PREFERRED EMBODIMENTS

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

Embodiments of the present invention may be useful with fluid dispensers, such as liquid fuel dispensers, which include a wireless communication module for each of two fueling positions at the dispenser. The wireless communication modules may be used to facilitate wireless acceptance of payments from mobile devices. Embodiments provide systems and methods which may be used to direct the radiation pattern of an antenna associated with each wireless communication module over a single fueling position and to prevent wireless communication between a mobile device at one fueling position and a wireless communication module associated with another fueling position (whether at the same dispenser or another dispenser in the fueling environment). Some embodiments also relate to increasing the signal strength of wireless communication modules associated with fuel dispensers.

Some embodiments of the present invention are particularly suitable for use with input devices in a retail service station environment, and the below discussion will describe preferred embodiments in that context. However, those of skill in the art will understand that the present invention is not so limited. In fact, it is contemplated that the present invention be used with any appropriate retail environment. Additionally, it is contemplated that the present invention be used with any type of fluid dispenser, including DEF and CNG dispensers, among others.

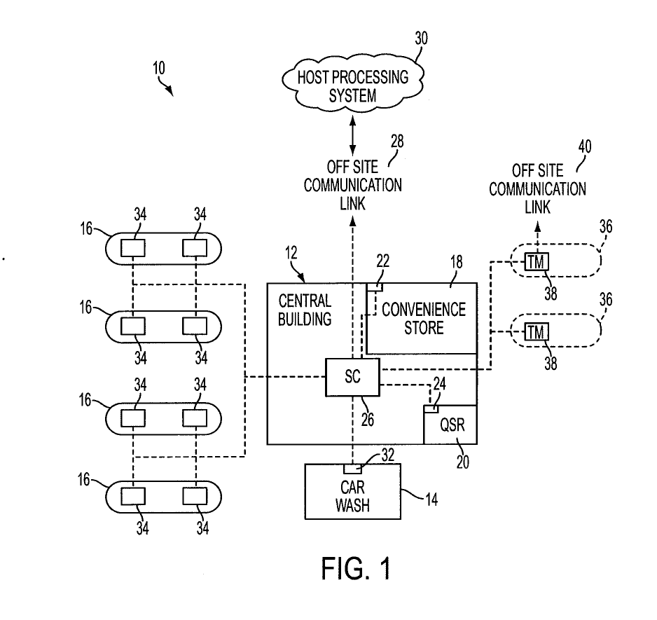

Referring now to FIG. 1, an exemplary fueling environment 10 may comprise a central building 12, a car wash 14, and a plurality of fueling islands 16. The central building 12 need not be centrally located within the fueling environment 10, but rather is the focus of the fueling environment 10, and may house a convenience store 18 and/or a quick serve restaurant 20 therein. Both the convenience store 18 and the quick serve restaurant 20 may include a point of sale (POS) 22, 24, respectively. POS 22, 24 may comprise a single computer or server operatively connected to an associated card reader and payment terminal. Additionally, POS 22, 24 may include a display, a touch screen, and/or other input devices.

The central building 12 may further house a site controller (SC) 26, which in an exemplary embodiment may be the PASSPORT® POS system, sold by Gilbarco Inc. of Greensboro, N.C., although third party site controllers may be used. Site controller 26 may control the authorization of fueling transactions and other conventional activities as is well understood, and site controller 26 may preferably be in operative communication with each POS. Alternatively, site controller 26 may be incorporated into a POS, such as point of sale 22 if needed or desired.

Further, site controller 26 may have an off-site communication link 28 allowing communication with a remote host processing system 30 for credit/debit card authorization, content provision, reporting purposes or the like, as needed or desired. In one embodiment, communication link 28 may be a stand alone router, switch, or gateway, although it should be appreciated that site controller 26 may additionally perform the functions of, and therefore replace, such a device. The off-site communication link 28 may be routed through the Public Switched Telephone Network (PSTN), the Internet, both, or the like, as needed or desired. Remote host processing system 30 may comprise at least one server maintained by a third party, such as a financial institution. Although only one remote host processing system 30 is illustrated, those of skill in the art will appreciate that in a retail payment system allowing payment via payment devices issued by multiple payment card companies or financial institutions, site controller 26 may be in communication with a plurality of remote host processing systems 30.

Car wash 14 may have a POS 32 associated therewith that communicates with site controller 26 for inventory and/or sales purposes. Car wash 14 alternatively may be a stand alone unit. Note that car wash 14, convenience store 18, and quick serve restaurant 20 are all optional and need not be present in a given fueling environment.

Fueling islands 16 may have one or more fuel dispensers 34 positioned thereon. Fuel dispensers 34 may be, for example, the ENCORE® fuel dispenser sold by Gilbarco Inc. of Greensboro, N.C. Fuel dispensers 34 are in electronic communication with site controller 26 through any suitable link, such as two wire, RS 422, Ethernet, wireless, etc. if needed or desired.

Fueling environment 10 also has one or more underground storage tanks (USTs) 36 adapted to hold fuel therein. As such, USTs 36 may each be a double walled tank. Further, each UST 36 may include a tank monitor (TM) 38 associated therewith. Tank monitors 38 may communicate with fuel dispensers 34 (either through site controller 26 or directly, as needed or desired) to determine amounts of fuel dispensed and compare fuel dispensed to current levels of fuel within USTs 36 to determine if USTs 36 are leaking.

Tank monitor 38 may communicate with site controller 26 and further may have an off-site communication link 40 for leak detection reporting, inventory reporting, or the like. Much like off-site communication link 28, off-site communication link 40 may be through the PSTN, the Internet, both, or the like. If off-site communication link 28 is present, off-site communication link 40 need not be present and vice versa, although both links may be present if needed or desired.

Further information on and examples of fuel dispensers and retail fueling environments are provided in U.S. Pat. No. 6,435,204 (entitled “Fuel Dispensing System”); U.S. Pat. No. 5,956,259 (entitled “Intelligent Fueling”); U.S. Pat. No. 5,734,851 (entitled “Multimedia Video/Graphics in Fuel Dispensers”); U.S. Pat. No. 6,052,629 (entitled “Internet Capable Browser Dispenser Architecture”); U.S. Pat. No. 5,689,071 (entitled “Wide Range, High Accuracy Flow Meter”); U.S. Pat. No. 6,935,191 (entitled “Fuel Dispenser Fuel Flow Meter Device, System and Method”); and U.S. Pat. No. 7,289,877 (entitled “Fuel Dispensing System for Cash Customers”), all of which are incorporated herein by reference in their entireties for all purposes. An exemplary tank monitor 38 may be the TLS-450 manufactured and sold by the Veeder-Root Company of Simsbury, Conn. For more information about tank monitors and their operation, reference is made to U.S. Pat. No. 5,423,457 (entitled “Real time tank product loss detection system”); U.S. Pat. No. 5,400,253 (entitled “Automated Statistical Inventory Reconciliation System for Convenience Stores and Auto/truck Service Stations”); U.S. Pat. No. 5,319,545 (entitled “System to Monitor Multiple Fuel Dispensers and Fuel Supply Tank”); and U.S. Pat. No. 4,977,528 (entitled “Apparatus and Method for Determining the Amount of Material in A Tank”), all of which are incorporated by reference herein in their entireties for all purposes.

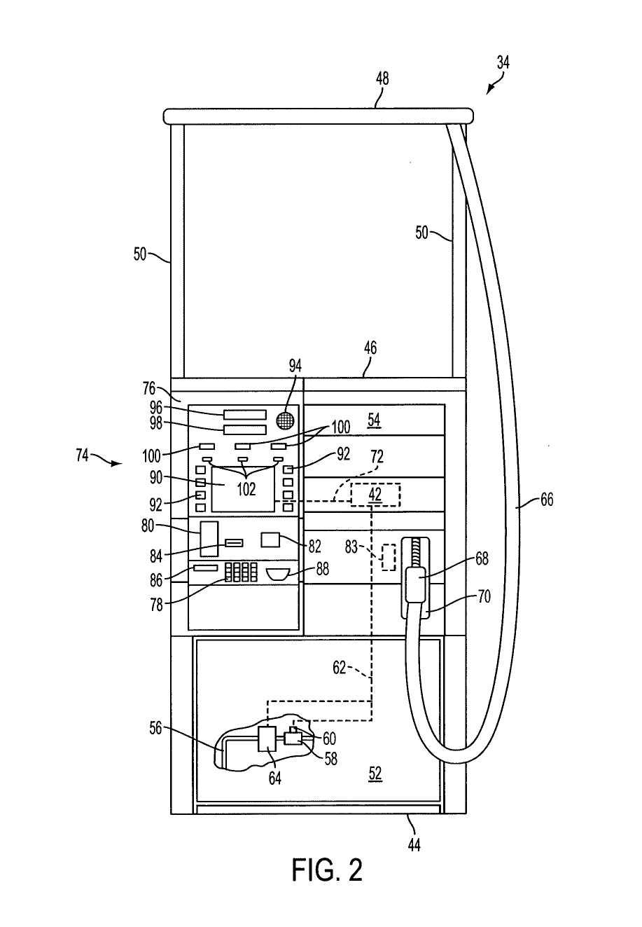

FIG. 2 illustrates a fuel dispenser 34 that may operate in association with site controller 26. Dispenser 34 includes a control system 42, which may be a processor, microprocessor, controller, microcontroller, or other suitable electronics with associated memory and software programs running thereon. In a preferred embodiment, control system 42 is comparable to the microprocessor-based control systems used in CRIND and TRIND type units sold by Gilbarco Inc. Control system 42 is in operative communication with site controller 26. Control system 42 further controls various aspects of the fuel dispenser 34 as described in more detail below.

The memory of control system 42 may be any suitable memory or computer-readable medium as long as it is capable of being accessed by the control system, including random access memory (RAM), read-only memory (ROM), erasable programmable ROM (EPROM), or electrically EPROM (EEPROM), CD-ROM, DVD, or other optical disk storage, solid-state drive (SSD), magnetic disc storage, including floppy or hard drives, any type of suitable non-volatile memories, such as secure digital (SD), flash memory, memory stick, or any other medium that may be used to carry or store computer program code in the form of computer-executable programs, instructions, or data. Control system 42 may also include a portion of memory accessible only to control system 42.

In the illustrated embodiment, dispenser 34 has a base 44 and a top 46, with a canopy 48 supported by two side panels 50. Fuel dispenser 34 is subdivided into multiple compartments. In this regard, a hydraulic area 52 encloses hydraulic components and an electronic area 54 encloses electronic components. A vapor barrier may be used to separate the hydraulic area 52 from the electronic area 54.

Several components used to control fuel flow may be housed within the hydraulic area 52. Fuel from USTs 36 is pumped through a piping network into inlet pipe 56. Fuel being dispensed passes though a meter 58, which is responsive to flow rate or volume. A displacement sensor 60 (e.g., a pulser) is employed to generate a signal in response to fuel flow though the meter 58. Signals indicative of the flow of fuel being dispensed are provided to control system 42 via control lines 62. Control/data lines 62 may provide control signaling to a valve 64 that may be opened and closed to permit or not permit dispensing of fuel.

Meter flow measurements from sensor 60 are collected by control system 42. Control system 42 also typically performs calculations such as cost associated with a fuel dispensing transaction. Additionally, control system 42 controls transactional processing at fuel dispenser 34 as will be described in more detail below.

As a dispensing transaction progresses, fuel is then delivered to a hose 66 and through a nozzle 68 into the customer's vehicle. Dispenser 34 includes a nozzle boot 70, which may be used to hold and retain nozzle 68 when not in use. Nozzle boot 70 may include a mechanical or electronic switch to indicate when nozzle 68 has been removed for a fuel dispensing request and when nozzle 68 has been replaced, signifying the end of a fueling transaction. A control line provides a signaling path from the electronic switch to control system 42. Control system 42 may use signaling received via the control line in order to make a determination as to when a transaction has been initiated or completed.

Control/data lines 72 provide electronic communication between control system 42 and a user interface 74. User interface 74 includes various combinations of subsystems to facilitate customer interaction with dispenser 34 and acceptance of payment for dispensed fuel. A bezel 76 acts as a lip around the various subsystems of interface 74. In most cases, bezel 76 is flush with the face of the fuel dispenser; however, in some embodiments it may extend outwardly from the face, in effect forming a raised lip. Bezel 76 may also comprise a plurality of sections that frame or house various subsystems or components.

As shown, user interface 74 includes several input devices with which embodiments of the present invention may be used. For example, user interface 74 may include a keypad 78. Keypad 78 is typically used for entry of a PIN if the customer is using a debit card for payment of fuel or other goods or services. In a preferred embodiment, keypad 78 may be the FlexPay™ encrypting PIN pad offered by Gilbarco Inc. User interface 74 may also include a secure card reader 80 for accepting credit, debit, or other chip or magnetic stripe cards for payment. Additionally, secure card reader 80 may accept loyalty or program-specific cards.

User interface 74 may also include other input devices such as a contactless card reader 82 (e.g., for integrated circuit or “smart” cards) and a wireless communication module 83, as discussed in more detail below. Further, user interface 74 may include other payment or transactional devices such as a bill acceptor 84, a receipt printer 86, and a change delivery device 88. Receipt printer 86 may provide a customer with a receipt of the transaction carried out at fuel dispenser 34. Change delivery device 88 may deliver change to a customer for overpayment. Other input devices, such as an optical reader and a biometric reader, are also contemplated.

A display 90 may be used to display information, such as transaction-related prompts and advertising, to the customer. In some embodiments, a touch screen may be used for display 90. In this case, display 90 may be configured to display a virtual keypad for receiving payment data such as a PIN of a debit card or the billing zip code of a credit card, for instance. Display 90 may also be used to receive a selection from the customer regarding the displayed information.

The customer may use soft keys 92 to respond to information requests presented to the user via the display 90. An intercom 94 may be provided to generate audible cues for the customer and to allow the customer to interact with an attendant. In addition, dispenser 34 may include a transaction price total display 96 that presents the customer with the price for fuel that is dispensed. A transaction gallon total display 98 may be used to present the customer with the measurement of fuel dispensed in units of gallons or liters. Octane selection buttons 100 may be provided for the customer to select which grade of fuel is to be dispensed before dispensing is initiated. Finally, price per unit (PPU) displays 102 may be provided to show the price per unit of fuel dispensed in either gallons or liters, depending on the programming of dispenser 34.

As noted above, embodiments of the invention relate to wireless communications between a fuel dispenser and mobile devices of customers who may use the fuel dispenser. In embodiments of the invention, wireless communications between a mobile device and the fuel dispenser may comprise any information that is typically provided to customers or exchanged between customers and retailers in a retail environment. For example, the wireless communications may comprise information related to payment of goods and services (such as payment information, account numbers and other cardholder data, and receipts), advertising or promotions, and/or loyalty programs, among other information. Enabling such communications requires emitting wireless signals (e.g., radio frequency signals) from wireless communication modules located in the dispenser. The wireless signals may be emitted generally toward the side of the fuel dispenser or fueling position at which the customer is located.

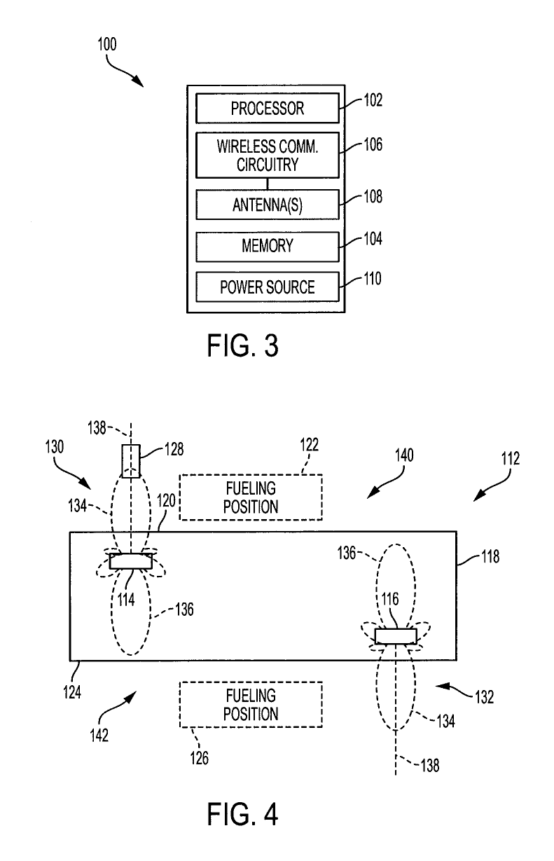

In this regard, FIG. 3 is a block diagram of a wireless communication module 100 which may be utilized with an embodiment of the present invention. As shown, wireless communication module 100 may comprise a processor 102 operative to carry out functional and control processing for module 100 as described herein. Processor 102 is preferably in electronic communication with a memory 104 and wireless communications circuitry 106. Wireless communications circuitry 106, which may comprise a wireless transceiver or radio, is preferably in operative communication with one or more antennas 108. Finally, a power source 110 is provided to power module 100. Power source 110 may be any suitable source of power operative to power the electronic components in module 100, including a battery, capacitor, or another energy storage device. Module 100 may be in electronic communication with a control system of the fuel dispenser with which it is associated, such as control system 42 described above.

Wireless communication module 100 is preferably operative to wirelessly communicate with a mobile device within the vicinity of module 100. Wireless communications between module 100 and a mobile device may be radio frequency signals with wavelengths in the ISM radio bands, though this is not required in all embodiments. In some embodiments, wireless communications may be implemented using a suitable short-range communications protocol, such as Bluetooth Low-Energy (also known as Bluetooth Smart), Peanut, Zigbee, Wi-Fi, or the like, though any suitable wireless communication protocol may be used with embodiments of the present invention. It will be appreciated that the permissible distance between module 100 and a mobile device will depend on the type of wireless communications used or the wireless communication standard implemented with module 100 and the signal strength of the module 100, among other factors.

In some embodiments, wireless communication circuitry 106 is preferably operative to emit and receive signals with frequencies between about 2.4 and 2.5 GHz via antennas 108. In one embodiment, module 100 may be analogous to commercially available Bluetooth Low-Energy “smart” beacons, such as the Gimbal™ beacon offered by Gimbal, Inc. or a beacon implementing the iBeacon proximity system developed by Apple Inc. In another embodiment, module 100 may be analogous to the wireless identity transmitters described in U.S. Pub. App. No. 2013/0217332, the entire disclosure of which is incorporated by reference herein for all purposes.

In some embodiments, the strength of the wireless signals emitted by antennas 108 and/or the power level of module 100 may preferably be adjustable to a desired level. For example, the signal strength or power level of a wireless communication module may need to be adjusted to accommodate different dispensers and fueling environments. Further, adjustment may be needed to ensure that the signal is strong enough to be received at a given fueling position of a fuel dispenser without being too strong such that it interferes with other wireless communications signals in the fuel dispenser or in the fueling forecourt.

FIG. 4 is a schematic top plan view of a fuel dispenser 112, which may be in many respects analogous to fuel dispenser 34. Fuel dispenser 112 is a lane-oriented dispenser, and it comprises two wireless communication modules 114 and 116 that are disposed within the electronics compartment of a housing 118. Wireless communication modules 114, 116 are preferably in operative electronic communication with a control system of fuel dispenser 112 analogous to control system 42, described above. Housing 118 defines a first side 120 that faces a first fueling position 122 and a second side 124 that faces a second fueling position 126. Wireless communication module 114 is associated with fueling position 122, and wireless communication module 116 is associated with fueling position 126.

If possible, it is important to limit wireless emissions from a particular wireless communication module 114, 116 to the area about the particular fueling position 122, 126, respectively, with which it is associated. Otherwise, for example, a mobile device 128 at fueling position 122 may communicate with and/or receive signals from wireless communication module 116 or a wireless communication module associated with a nearby fuel dispenser, rather than with wireless communication module 114. (As used herein, the term “mobile device” refers broadly to any type of portable computing device operative to wirelessly communicate with other devices, and the term includes but is not limited to cell phones, tablet computers, and laptops.)

Miscommunications between a mobile device and a wireless communication module associated with another fueling position (or fuel dispenser altogether) may frustrate a customer's attempt to pay for a purchase or the system's attempt to communicate information, such as a receipt or advertising or promotional information, to the appropriate customer. These miscommunications may occur where the emissions from one wireless communication module are too strong or cover too large of an area, such that they are received by mobile devices on the other side of the dispenser (or at other fuel dispensers).

In developing embodiments of the present invention, proof-of-concept experiments were performed to determine the likelihood of such miscommunications occurring with various types of wireless communication modules and to reduce or eliminate their occurrence. In one experiment, each wireless communication module 114, 116 was installed in housing 118 and respectively positioned behind a section of each side 120, 124 of housing 118 that is on the right-hand side of a customer facing each side 120, 124. Thus when viewed from above, communication modules 114, 116 were diagonally spaced apart in housing 118. In this experiment, communication modules 114, 116 were Gimbal™ beacons.

In this regard, Gimbal™ beacons comprise an internal dipole antenna which emits a semi-omnidirectional signal. As explained above, however, to prevent miscommunications between mobile devices and communication modules, it was contemplated that highly directional signals would be more desirable. Gimbal™ beacons also comprise an internal patch antenna capable of emitting a more directional radiation pattern, and this antenna was used in the experiments. Thus, in use, the antennas 108 of wireless communication modules 114, 116 had radiation patterns 130, 132, respectively, as illustrated schematically in FIG. 4.

As shown, radiation patterns 130, 132 each comprise front lobes 134 and back lobes 136. Further, front lobes 134 each define a longitudinal axis 138. In this experiment, communication modules 114, 116 were oriented with respect to sides 120, 124 such that lobes 134 faced sides 120, 124. Or, in other words, such that longitudinal axes 138 extended generally perpendicularly to faces 120, 124. This orientation of communication modules 114, 116 caused there to be “dead spaces,” or signal null areas, 140, 142 in front of the left sides (when faced by a customer) of faces 120, 124 of dispenser 112.

Furthermore, in testing, it was discovered that radiation patterns 130, 132 did not have a large front-to-back ratio. For example, the difference in gain between the front 134 and back 136 lobes of the radiation patterns 130, 132 was measured to be only about 5 dB. Therefore, back lobe 136 of radiation pattern 130 could be detected at dead space 142, and back lobe 136 of radiation pattern 132 could be detected at dead space 140. The diagonal spacing of communication modules 114, 116 within housing 118, which was intended to limit overlap in radiation patterns, thus was found in some cases to frustrate wireless communications between a mobile device and the communication module associated with the fueling position at which the mobile device is located.

In contrast to the arrangement shown in FIG. 4, embodiments of the present invention may reduce or eliminate the possibility that a mobile device at a first fueling position associated with a first wireless communication module may communicate with and/or receive signals from a second wireless communication module associated with a second fueling position of the fuel dispenser or with another wireless communication module in the fuel dispensing environment. Embodiments of the invention may comprise a wireless communication assembly operative to both increase signal strength from a wireless communication module and focus wireless emissions from the wireless communication module over the fueling position with which it is associated. In embodiments, the wireless communication assembly may comprise a wireless communication module disposed within a waveguide. The waveguide may be operative to guide electromagnetic waves transmitted from the wireless communication module.

In developing embodiments of the present invention, attempts were made to improve the performance of the Gimbal™ beacon's patch antenna and the potential for miscommunications described above. In particular, a wireless communication module was placed within an aluminum box having one open end to act as a shield and as a “horn reflector.” The wireless communication module was secured against the closed end such that the front lobe of its radiation pattern radiated toward the open end. Tests were performed with boxes of various lengths, including 118 mm, 180 mm, and 273 mm.

It was discovered that using the wireless communication module with even the shortest aluminum box increased signal strength, which may help prevent interference by other signals and avoid miscommunications or other transaction problems. Further, the 273 mm box increased signal gain by approximately 7 dB relative to the 118 mm box, and the 180 mm box increased gain by approximately 3 dB relative to the 118 mm box. However, none of the aluminum boxes appreciably changed the small front-to-back ratio; in all three cases, the change in front-to-back ratio was approximately +/−2 dB. Because of this, use of the aluminum box did not eliminate the problem of the back lobe of one wireless communication module extending into a “dead space” on the other side of the fuel dispenser, where it could be received by a mobile device that is intended to communicate with a different wireless communication module.

In other words, the problem was not just one of signal strength and shielding, but also one of orientation. As discussed in more detail below, it was discovered that disposing the wireless communication module at an angle relative to the side of the dispenser with which it is associated desirably improved the performance of wireless communications between the fuel dispenser and mobile devices. By angling the longitudinal axis of a waveguide containing a wireless communication module with respect to the fueling position, the antenna's radiation pattern better covers a fueling position and reduces or eliminates the “dead spaces” described above.

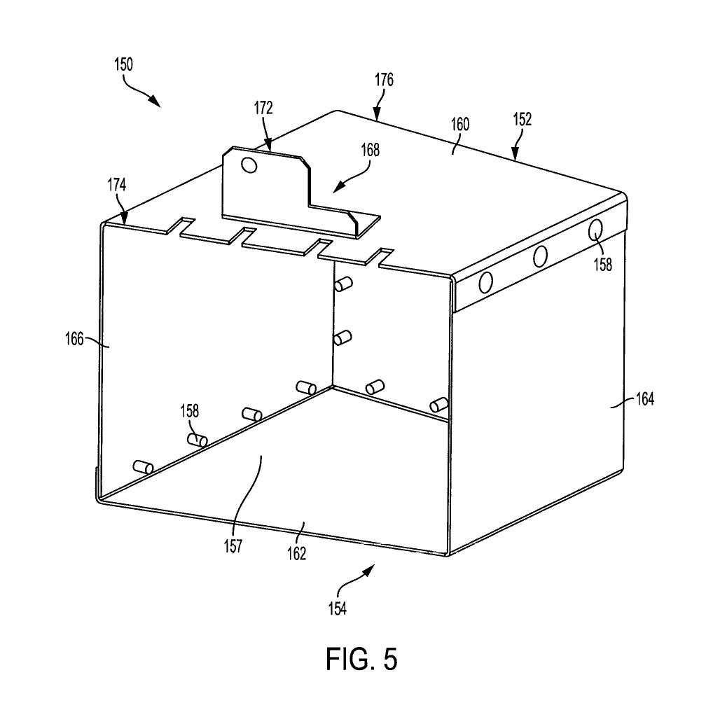

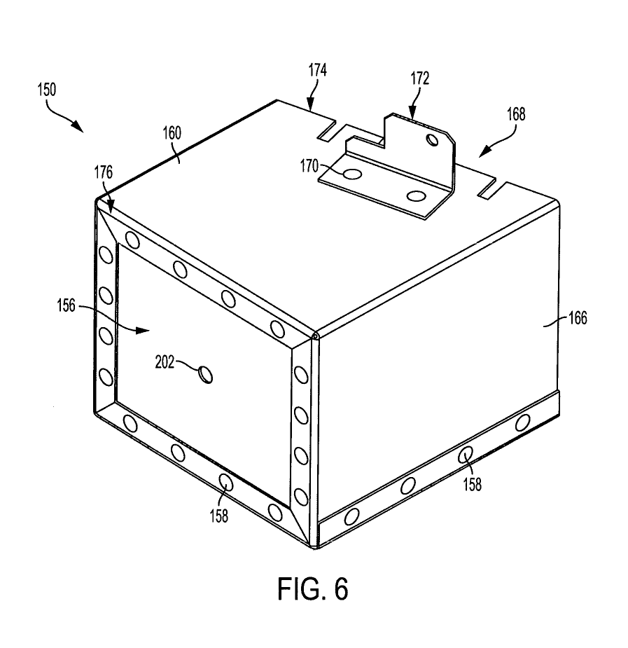

In this regard, FIG. 5 is a front perspective view of a waveguide 150 constructed in accordance with an embodiment of the present invention. FIG. 6 is a back perspective view of waveguide 150. Referring to these figures, waveguide 150 comprises a housing 152 that defines an open first end 154, a generally closed second end 156, and an open interior channel 157. In the illustrated embodiment, housing 152 is box-shaped, having a generally rectangular cross-section. In other embodiments, however, housing 152 need not be box-shaped, and it may instead define a cross-section of circular, polygonal, or another suitable shape. Housing 152 may preferably be formed of a suitable lightweight metal material, such as 18 gauge aluminum. As shown, housing 152 is formed by a plurality of folded aluminum sheets fastened together by rivets 158. When formed, housing 152 may comprise a top 160, a bottom 162, a first side 164, and a second side 166.

Waveguide 150 is preferably configured for installation inside a fuel dispenser, such as fuel dispenser 34 or 112, described above. In many cases, waveguide 150 will be disposed within the electronics area or cabinet of the fuel dispenser. In one embodiment, first end 154 may be mounted against or flush with an interior wall of the fuel dispenser electronics area. Thus, a mounting bracket 168 may be coupled with waveguide 150 in some embodiments. Mounting bracket 168, which may also be attached to waveguide 150 via rivets 170, preferably defines a vertical flange 172 via which waveguide 150 may be connected to the interior wall.

As shown in FIGS. 5 and 6, in some embodiments, first side 164 may be shorter in length than second side 166, and the top 160 and bottom 162 may each reduce in length in a linear fashion between second side 166 and first side 164. In other words, top 160 and bottom 162 may be tapered along their forward edges to compensate for the change in length between second side 166 and first side 164. The forward edges of top 160, bottom 162, first side 164, and second side 166 may lie along a first plane 174, and closed second end 156 may lie along a second plane 176 spaced apart from the first plane. It will be appreciated that first plane 174 is not parallel with second plane 176 in this embodiment, but rather first plane 174 is angled with respect thereto. Thus, and also as explained below, when a wireless communication assembly comprising waveguide 150 is coupled with an interior wall of a fuel dispenser electronics area, first plane 174 may be generally parallel with the interior wall, and second plane 176 (and second end 156) may be angled by the same amount with respect to the interior wall. Correspondingly, a longitudinal axis of waveguide 150 (extending parallel to first side 164 and second side 166) may be at the same angle from a line extending perpendicular to the interior wall and to the associated fueling position.

In one embodiment, waveguide 150 may be approximately 116 mm in width and 93 mm in height. Also, second side 166 may be about 120 mm in length and first side 164 may be about 89 mm in length. Further, the forward edges of top 160 and bottom 162 may be at an angle of about 15 degrees with respect to the rear edges of top 160 and bottom 162 (see FIG. 8). Accordingly, first plane 174 is at an angle of about 15 degrees with respect to second plane 176, and a longitudinal axis of waveguide 150 is at an angle of about 15 degrees from a line extending perpendicular to an interior wall of a fuel dispenser when waveguide 150 is mounted thereon. Of course, these dimensions are merely exemplary, and those of skill in the art will appreciate that these dimensions may vary without affecting the operation of embodiments of the present invention. For example, in some embodiments the angle of first plane 174 with respect to second plane 176 may be 5 degrees, and in others it may be 45 degrees. Further, the dimensions of housing 152 may vary with the size and shape of a wireless communication module which may be disposed therein, and as noted above, housing 152 need not have a rectangular cross-sectional area in all embodiments. Those of skill in the art will be able to select suitable dimensions for waveguide 150 based on the desired radiation pattern from and size needed to accommodate a given wireless communication module; the type and characteristics (e.g., wavelength) of wireless communications propagated along waveguide 150; the internal geometry of the fuel dispenser electronics area and the need to conveniently mount the wireless communication module; the external features of the fuel dispenser and its fueling position(s); and the arrangement of the fueling environment, among other factors.

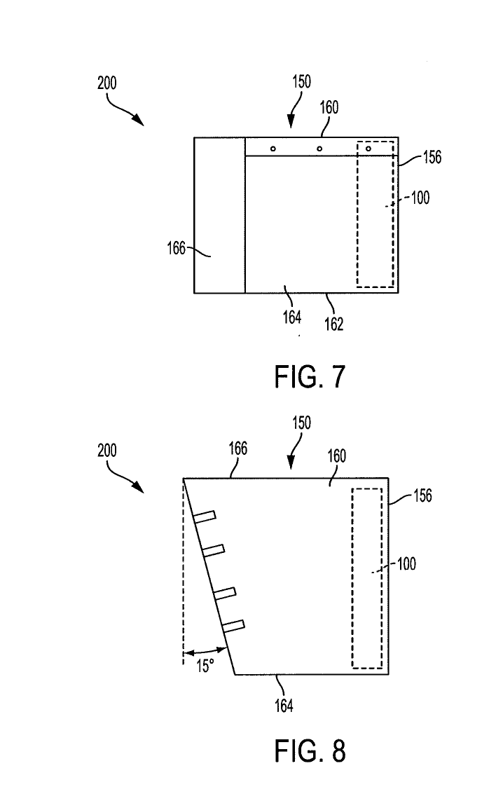

As noted above, embodiments of the present invention comprise a wireless communication assembly. In this regard, FIG. 7 is a left side elevation of a wireless communication assembly 200 in accordance with an embodiment of the present invention, and FIG. 8 is a top plan view of wireless communication assembly 200. In the illustrated embodiment, assembly 200 comprises waveguide 150 and wireless communication module 100, both described above. Here, however, bracket 168 is not shown, though it may be included in some embodiments.

Wireless communication module 100 may be coupled with waveguide 150 in its interior channel 157. In particular, in this embodiment, wireless communication module 100 may be generally rectangular in shape and the interior dimensions of waveguide 150 may be slightly greater than the exterior dimensions of wireless communication module 100. Thus, wireless communication module may be disposed within channel 157 against generally closed second end 156. Referring again to FIG. 6, second end 156 may define a threaded aperture 202 sized to receive a suitable fastener (such as a ¼-20 screw) by which wireless communication module 100 may be secured with waveguide 150.

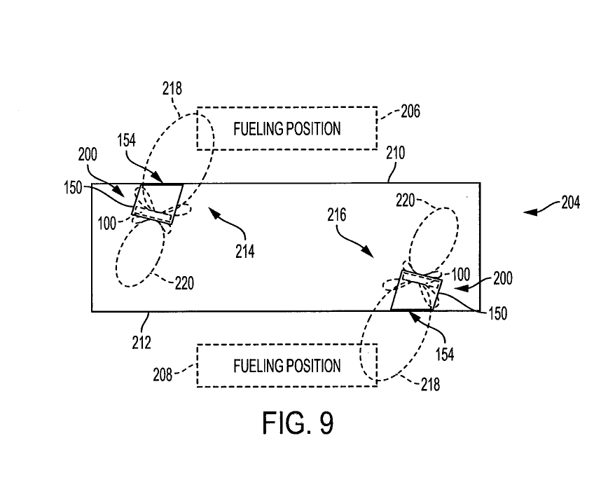

Notably, embodiments of wireless communication assembly 200 dramatically improve the reliability of wireless communications between a fuel dispenser and a mobile device relative to the arrangement discussed above with reference to FIG. 4. For example, FIG. 9 is a schematic top plan view of a fuel dispenser 204. Fuel dispenser 204, which is preferably analogous in many respects to fuel dispensers 34 and 112, described above, is a lane-oriented dispenser, and fueling positions 206, 208 are provided on sides 210, 212 of fuel dispenser 204, respectively. Fuel dispenser 204 comprises two wireless communication assemblies 200 in accordance with an embodiment of the present invention.

As shown in FIG. 9, wireless communication assemblies 200 are disposed within fuel dispenser 204 such that open ends 154 of waveguides 150 engage an interior wall of the electronics area of fuel dispenser 204. In one embodiment, for example, wireless communication assemblies 200 may be coupled with an interior surface of the polycarbonate doors which open to the electronics area of fuel dispenser 204. It will be appreciated, however, that in other embodiments wireless communication assemblies 200 need not be in direct physical contact with, and may be spaced apart from, the interior wall of a fuel dispenser.

The antennas 108 of wireless communication modules 100 have radiation patterns 214, 216. Radiation patterns 214, 216 each comprise front lobes 218 and back lobes 220. As shown, communication modules 100 within waveguides 150 are oriented with respect to sides 210, 212 such that lobes 218 are at an angle to sides 210, 212 and to fueling positions 206, 208. Further, by disposing each wireless communication assembly 200 at an angle relative to its associated fueling position 206, 208 and/or side 210, 212 of fuel dispenser 204, back lobes 220 are spaced farther apart. As shown schematically in FIG. 9, back lobes 220 are also each shifted away from what was once “dead space,” toward the lateral sides of dispenser 214. (Indeed, in some embodiments, and depending on the angle of modules 200, back lobes 220 may extend completely out of each lateral side of dispenser 204.) As a result, the likelihood that a mobile device at fueling position 208 will communicate with the wireless communication module 200 associated with fueling position 206 on the opposite side of fuel dispenser 204 is eliminated or greatly reduced.

In another embodiment, a ground strap or ground wire may be operatively connected with a wireless communication assembly to further improve the reliability of wireless communications between communications modules and mobile devices. The ground strap may be coupled with closed end 156 of waveguide 150, in one example. In testing, grounding the waveguide was shown to improve signal strength of a wireless communication module by approximately 5 dB. Those of skill in the art will appreciate that this may further reduce the amount of “dead space” at a given fueling position and decrease the likelihood that a mobile device will receive signals from a wireless communication module on the opposite side of the fuel dispenser from the mobile device.

Based on the above, it will be appreciated that embodiments of the invention provide systems and methods for facilitating wireless communication between wireless communication module associated with a fueling position of a fuel dispenser and a mobile device of a customer at the fueling position. Embodiments of the present invention may intensify the signal of an antenna associated with a wireless communication module and direct the signal in an intended direction to better “illuminate,” or cover, the area in front of a fuel dispenser. Further, embodiments may better isolate multiple wireless communication modules within a single fuel dispenser from one another and from other fuel dispensers in a fuel dispensing environment. While one or more preferred embodiments of the invention have been described above, it should be understood that any and all equivalent realizations of the present invention are included within the scope and spirit thereof. The embodiments depicted are presented by way of example only and are not intended as limitations upon the present invention. Thus, it should be understood by those of ordinary skill in this art that the present invention is not limited to these embodiments since modifications can be made. Therefore, it is contemplated that any and all such embodiments are included in the present invention as may fall within the scope and spirit thereof.

What is claimed is:

1. A fuel dispenser, comprising:
a housing defining an electronics area therein;
the housing having a first side and a second side, the first and second sides respectively facing first and second fueling positions associated with the fuel dispenser;
a first side axis that is perpendicular to the first side and a second side axis that is perpendicular to the second side;
a first wireless communication module disposed in the electronics area, the first wireless communication module comprising wireless communication circuitry in electrical communication with at least one antenna; and
a first waveguide disposed in the electronics area and operative to guide electromagnetic waves transmitted from the first wireless communication module toward the first fueling position, the first waveguide having a first longitudinal axis;
wherein the first waveguide is positioned such that the first longitudinal axis is at a first angle with respect to the first side axis.

2. The fuel dispenser of claim 1, wherein the electromagnetic waves have a frequency between about 2.4 GHz and about 2.5 GHz.

3. The fuel dispenser of claim 1, wherein the first angle is between about 5 degrees and about 45 degrees.

4. The fuel dispenser of claim 3, wherein the first angle is about 15 degrees.

5. The fuel dispenser of claim 1, further comprising a second wireless communication module disposed in the electronics area, the second wireless communication module comprising wireless communication circuitry in electrical communication with at least one antenna.

6. The fuel dispenser of claim 5, further comprising a second waveguide disposed in the electronics area and operative to guide electromagnetic waves transmitted from the second wireless communication module toward the second fueling position, the second waveguide having a second longitudinal axis.

7. The fuel dispenser of claim 6, wherein the second waveguide is positioned such that the second longitudinal axis is at a second angle with respect to the second side axis.

8. The fuel dispenser of claim 7, wherein the second angle is the same as the first angle.

9. The fuel dispenser of claim 7, wherein the first longitudinal axis is parallel with the second longitudinal axis.

10. The fuel dispenser of claim 1, wherein the waveguide is formed from aluminum.

11. The fuel dispenser of claim 1, wherein the first wireless communication module is operative to wirelessly communicate with mobile devices at the first fueling position.

12. A wireless communication assembly for use in a fuel dispensing environment, the wireless communication assembly comprising:
a housing having a first end and a second end, the second end having an opening therethrough, the first end parallel with a first plane and second end opening parallel with a second plane; and
a wireless communication module disposed in the housing, the wireless communication module comprising wireless communication circuitry in electrical communication with at least one antenna;
the housing being operative to guide electromagnetic waves transmitted by the wireless communication module toward the second end;
wherein the first and second planes are not parallel.

13. The wireless communication assembly of claim 12, wherein the housing defines a rectangular cross-section.

14. The wireless communication assembly of claim 13, wherein the housing defines first and second sides extending between the first and second ends, the first side being longer than the second side.

15. The wireless communication assembly of claim 13, further comprising a ground strap in electrical communication with the housing.

16. The wireless communication assembly of claim 13, wherein the housing is formed of aluminum.

17. The wireless communication assembly of claim 13, wherein the second plane is at an angle relative to the first plane, the angle being between about 5 degrees and about 45 degrees.

18. The wireless communication assembly of claim 17, wherein the angle is about 15 degrees.

19. The wireless communication assembly of claim 13, wherein the housing is configured for attachment with a fuel dispenser door.

20. The wireless communication assembly of claim 13, wherein the wireless communication module is operative to transmit radio frequency signals to and receive radio frequency signals from a mobile device.
